(19) United States
(12) Patent Application Publication
(10) Pub. No.: US 2003/0115208 A1
(43) Pub. Date: Jun. 19, 2003

(54) Access right management system, access right management method and program therefor

(75) Inventors: Asuka Fujiwara, Tokyo (JP); Masaaki Nakano, Osaka (JP); Ryuichi Tamano, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/317,108

(22) Filed: Dec. 12, 2002

(30) Foreign Application Priority Data
Dec. 14, 2001 (JP) 2001-381627

(51) Int. Cl. G06F 7/00

(52) U.S. Cl. 707/100

(57) ABSTRACT

If a document is to be referred to in this access right management system of the present invention, a name of the document desired to be referred and a personal information number of a person who refers to the document, are transmitted from a document reference apparatus to a document reference section. The document reference section acquires document data from a document storage section based on the transmitted document name, and transmits the personal information number to a reference section. The reference section acquires personal information from a personal information storage section based on the personal information number, and transmits the result to the document reference section. The document reference section passes the personal information and the document data to a condition determination section, and the condition determination section determines whether or not an access is acceptable. If a determination result of the condition determination section indicates that the access is acceptable, the document reference section transmits the document data to the document reference apparatus. If it indicates the access is rejected, the document reference section transmits an access rejection notification to the document reference apparatus.

### BACKGROUND OF THE INVENTION

1. Field of the Invention

The present invention relates to an access right management system, an access right management method and a program therefor. More specifically, the present invention relates to an access right management system, an access right management method and a program therefor utilizing personal information.

2. Description of the Related Art

Conventionally, access right is managed by registering persons in groups to which they belong to thereby form groups, and permitting only a specific person or specific group to access files.

As prior inventions similar to technical field in the present invention, there is known, for example, Japanese Patent Unexamined Application Publication No. 2000-259476 which discloses “a file management system and a server calculator”. The file management system and the server calculator are intended to appropriately realize file access by defining a plurality of groups to which each person belongs and defining one security level per person.

However, the conventional access right management has the following disadvantages.

First, if the groups to which a certain person belongs are changed due to reshuffle, it is necessary to update all information on groups to which the person belongs and man-hours for the update processing disadvantageously increases as the number of groups increases.

Second, only the persons permitted to update group information can manage the respective groups.

Third, the number of groups disadvantageously increases. For example, if there are groups Ga and Gb and a access right setting is to be made to users who belong to the both groups Ga and Gb, it is disadvantageously necessary to prepare a new group Gab which is constituted by users who belong to the both groups Ga and Gb.

Further, according to the conventional invention, if a security level is grasped based on a group to which each person belongs, only one security level can be defined per group.

### SUMMARY OF THE INVENTION

The present invention has been made to solve the above-stated disadvantages. It is an object of the present invention to provide an access right management system, an access right management method and a program therefor capable of decreasing man-hours required to manage groups as required conventionally by managing personal information on persons who desire to access files on a person-by-person basis using the file service function and the like of a groupware.

To solve the problem, the invention is characterized in that a storage apparatus storing a plurality of pieces of data, a reference apparatus referring to the data stored in the storage apparatus, and a personal information storage apparatus storing a plurality of pieces of personal information used to determine an access right for accessing desired data from the reference apparatus, are connected through transmission lines, and the plurality of pieces of personal information are managed on a person-by-person basis.

The invention is characterized in that the storage apparatus comprises: data storage means for allocating reference conditions to the plurality of pieces of data, and storing the plurality of pieces of data allocated the reference conditions; data reference means for acquiring the desired data and the reference condition of the desired data from the storage means in response to a data reference request transmitted from the reference apparatus, and for acquiring personal information for determining whether or not the access right for accessing the desired data is to be authorized, from the personal information storage apparatus; and condition determination means for determining whether or not the personal information coincides with the reference condition of the desired data acquired from the data reference means.

The invention is characterized in that if the personal information coincides with the reference condition of the desired data, the storage apparatus causes the condition determination section to transmit the desired data to the reference apparatus, and that if the personal information does not coincide with the reference condition of the desired data, the storage apparatus causes the condition determination section to transmit a notification that an access to the desired data is rejected, to the reference apparatus.

The invention is characterized in that the personal information comprises: a personal information number specific to a person; and personal data consisting of a plurality of categories used to determine the access right for accessing the desired data.

The invention is characterized in that the personal information storage apparatus comprises: personal information storage means for storing the plurality of pieces of personal information; and personal information reference means for acquiring one of the plurality of pieces of personal information stored in the personal information storage means based on the personal information number transmitted together with a personal information acquisition request from the storage apparatus in response to the acquisition request, and for transmitting the acquired personal information to the storage apparatus.

The invention is characterized in that if the personal information based on the personal information number transmitted together with the personal information acquisition request is not stored in the personal information storage means, the personal information reference means transmits a notification, that the personal information does not exist, to the storage appratus.

The invention is characterized in that the personal information storage apparatus comprises: update means for updating the plurality of pieces of personal information stored in the personal information storage means.

The invention is characterized by comprising: a personal information change apparatus changing the personal information stored in the personal information storage means, from an outside of the access right management system, and characterized in that the update means updates the personal information stored in the personal information storage means based on the personal information number and a change content of the personal information transmitted from the personal information change apparatus.

The invention a method for managing an access right management system in which a storage apparatus storing a plurality of pieces of data, a reference apparatus referring to the data stored in the storage apparatus, and a personal information storage apparatus storing a plurality of pieces of personal information used to determine an access right for accessing desired data from the reference apparatus are connected through transmission lines, the method characterized by comprising: a reference request transmission step of causing the reference apparatus to transmit a data name of data to which a person desires to refer and a personal information number of the person who desires to refer to the data, to the storage apparatus; a data acquisition step of causing the storage apparatus to acquire the data based on the data name transmitted in the reference request transmission step; a personal information acquisition step of causing the storage apparatus to acquire the personal information based on the personal information number, from the personal information storage apparatus; a determination step of causing the storage apparatus to determine whether or not the personal information acquired in the personal information acquisition step coincides with a reference condition allocated to the data acquired in the data acquisition step; and a transmission step of causing the storage apparatus to transmit the desired data to the reference apparatus if the personal information coincides with the reference condition, and to transmit a notification that an access is rejected to the reference apparatus if the personal information does not coincide with the reference condition.

The invention is characterized in that the personal information comprises: the personal information number specific to the person; and personal data consisting of a plurality of categories used to determine the access right for accessing the desired data.

The invention is characterized by comprising: a personal information storage step of causing the personal information storage apparatus to store the plurality of pieces of personal information on a person-by-person basis; and a personal information reference step of causing the personal information storage apparatus to acquire the personal information stored in the personal information storage step based on the personal information number transmitted together with a personal information acquisition request transmitted from the storage apparatus in the personal information acquisition step, in response to the personal information acquisition request, and to transmit the acquired personal information to the storage apparatus.

The invention is characterized in that in the personal information reference step, if the personal information based on the personal information number transmitted together with the personal information acquisition request is not stored in the personal information storage step, the personal information reference step transmits a notification, that the personal information does not exist, to the storage apparatus.

The invention is characterized by comprising: an update step of causing the personal information storage apparatus to update the plurality of pieces of personal information stored in the personal information storage step.

The invention is characterized in that the access right management system comprises: a personal information change apparatus changing the personal information stored in the personal information storage apparatus, from an outside of the access right management system, and in that in the update step, the personal information storage apparatus updates the personal information stored in the personal information storage step based on the personal information number and a change content of the personal information transmitted from the personal information change apparatus.

The invention is a program for an access right management system, the system comprising: a storage apparatus storing a plurality of pieces of data; a reference apparatus referring to the data stored in the storage apparatus; and a personal information storage apparatus storing a plurality of pieces of personal information consisting of a plurality of categories used to determine an access right for accessing desired data from the reference apparatus, wherein the storage apparatus, the reference apparatus, and the personal information storage apparatus are connected through transmission lines, the program characterized in that the program causes the reference apparatus to execute a reference request transmission processing of transmitting a data name of data to which a person desires to refer and a personal information number of the person who desires to refer to the data, to the storage apparatus; the program causes the storage apparatus to execute a data acquisition processing of acquiring the data based on the data name transmitted by the reference request transmission processing; the program causes the storage apparatus to execute a personal information acquisition processing of acquiring the personal information based on the personal information number, from the personal information storage apparatus; the program causes the storage apparatus to execute a determination processing of determining whether or not the personal information acquired in the personal information acquisition step coincides with a reference condition allocated to the data acquired by the data acquisition processing; and in that the program causes the storage apparatus to execute a transmission processing of transmitting the desired data to the reference apparatus if the personal information coincides with the reference condition, and of transmitting a notification that an access is rejected to the reference apparatus if the personal information does not coincide with the reference condition.

The invention is characterized in that the personal information comprises: the personal information number specific to the person; and personal data consisting of a plurality of categories used to determine the access right for accessing the desired data.

The invention is characterized in that the program causes the personal information storage apparatus to execute a personal information storage processing of storing the plurality of pieces of personal information on a person-by-person basis; and in that the program causes the personal information storage apparatus to execute a personal information reference processing of acquiring the personal information stored by the personal information storage processing based on the personal information number transmitted together with a personal information acquisition request transmitted from the storage apparatus by the personal information acquisition processing, in response to the personal information acquisition request, and of transmitting the acquired personal information to the storage apparatus.

The invention is characterized in that in the personal information reference processing, if the personal information based on the personal information number transmitted together with the personal information acquisition request is not stored by the personal information storage processing, the personal information storage apparatus transmits a notification, that the personal information does not exist, to the storage apparatus.

The invention is characterized in that the program causes the personal information storage apparatus to execute an update processing of updating the plurality of pieces of personal information stored by the personal information storage processing.

The invention is characterized in that the access right management system comprises: a personal information change apparatus changing the personal information stored in the personal information storage apparatus, from an outside of the access right management system, and in that in the update processing, the personal information storage apparatus updates the personal information stored by the personal information storage processing based on the personal information number and a change content of the personal information transmitted from the personal information change apparatus.

### BRIEF DESCRIPTION OF THE DRAWINGS

FIG. 1 is a block diagram showing a schematic configuration of a system in which an access right management system in the first embodiment of the present invention is employed in document data management;

FIG. 2 is a plan view showing a configuration of personal document data stored in a document storage section;

FIG. 3 is a plan view showing the configuration of personal information stored in a personal information storage section;

FIG. 4 is a block diagram showing the schematic configuration of a system in which an access management system in the second embodiment of the present invention is employed in document data management;

FIG. 5 is a plan view showing an example of personal information for update transmitted from a personal information change apparatus;

FIG. 6 is a plan view showing an example of personal information stored in the personal information storage section after the update; and

FIG. 7 is a plan view showing an example of personal information stored in the personal information storage section after personal information is deleted based on a deletion instruction.

### DESCRIPTION OF THE PREFERRED EMBODIMENTS

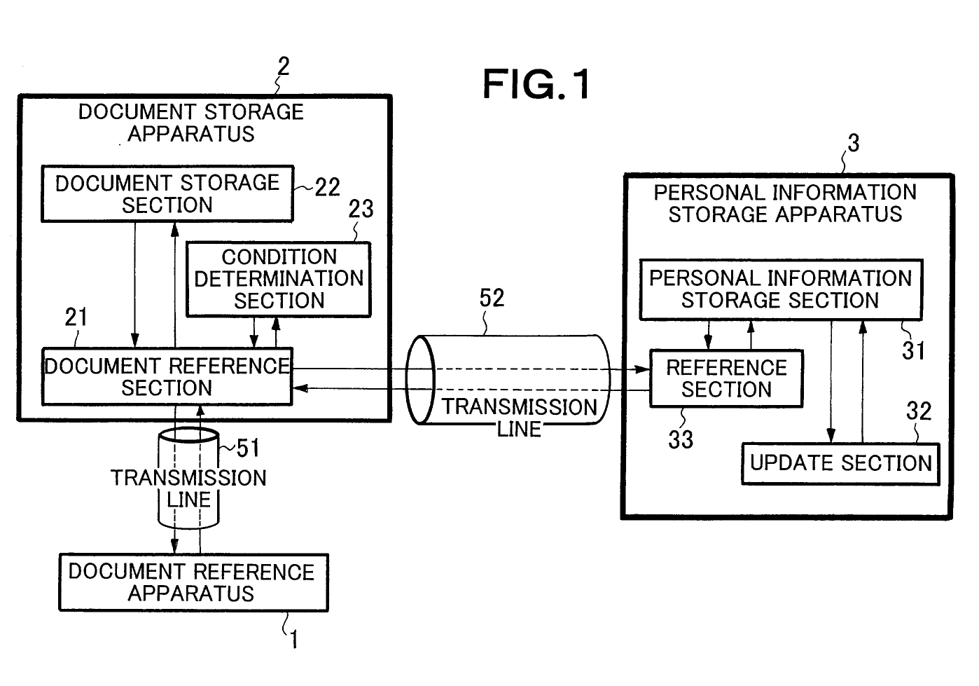

Embodiments of an access right management system, an access right management method and a program therefor according to the present invention will be described hereinafter with reference to the accompanying drawings. FIGS. 1 to 6 show the embodiments of an access right management system, an access right management method and a program therefor according to the present invention.

<First Embodiment>

FIG. 1 is a block diagram showing the schematic configuration of the first embodiment in which an access right management system according to the present invention is applied to document data management. In FIG. 1, the access right management system in the first embodiment according to the present invention includes a document reference apparatus 1, a document storage apparatus 2, and a personal information storage apparatus 3. The document reference apparatus 1 and the document storage apparatus 2 are connected to each other through a transmission line 51, while the document storage apparatus 2 and the personal information storage apparatus 3 are connected to each other through a transmission line 52.

The document reference apparatus 1 is employed to refer to document data. The document reference apparatus 2 includes a document reference section 21 referring to document data, a document storage section 22 storing document data, and a condition determination section 23 operating under the control of a program. The personal information storage apparatus 3 includes a personal information storage section 31 storing personal information, an update section 32 updating the personal information stored in the personal information storage section 31, and a reference section 33 referring to the personal information.

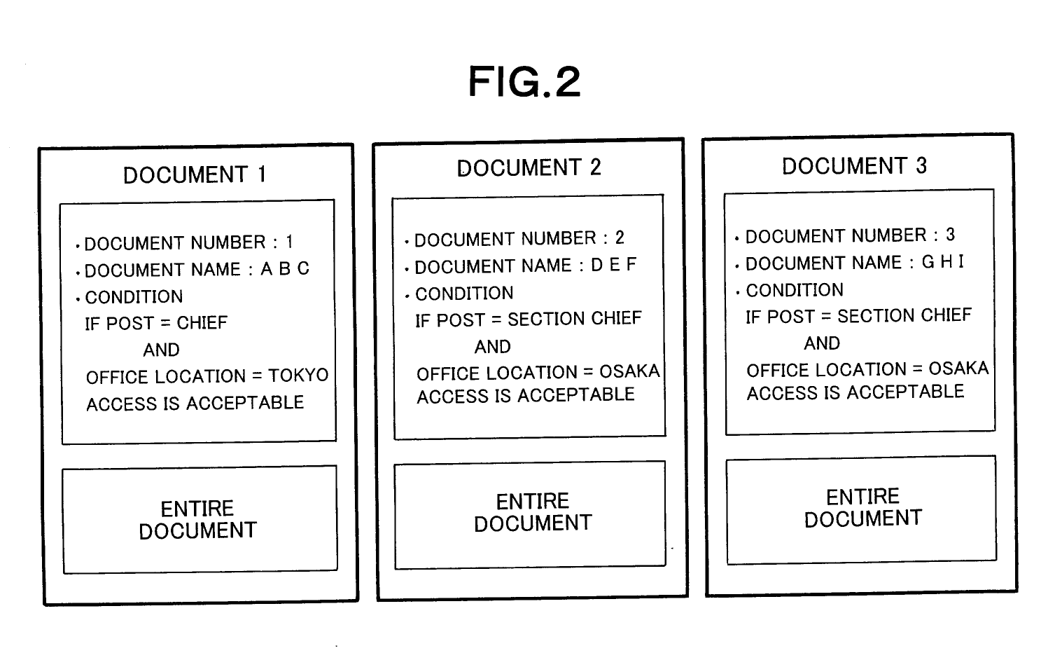

FIG. 2 is a plan view showing an example of pieces of personal document data stored in the document storage section 22. As shown in FIG. 2, each personal document data includes document information which consists of “document number”, “document name”, “condition” and the like, and an entire document.

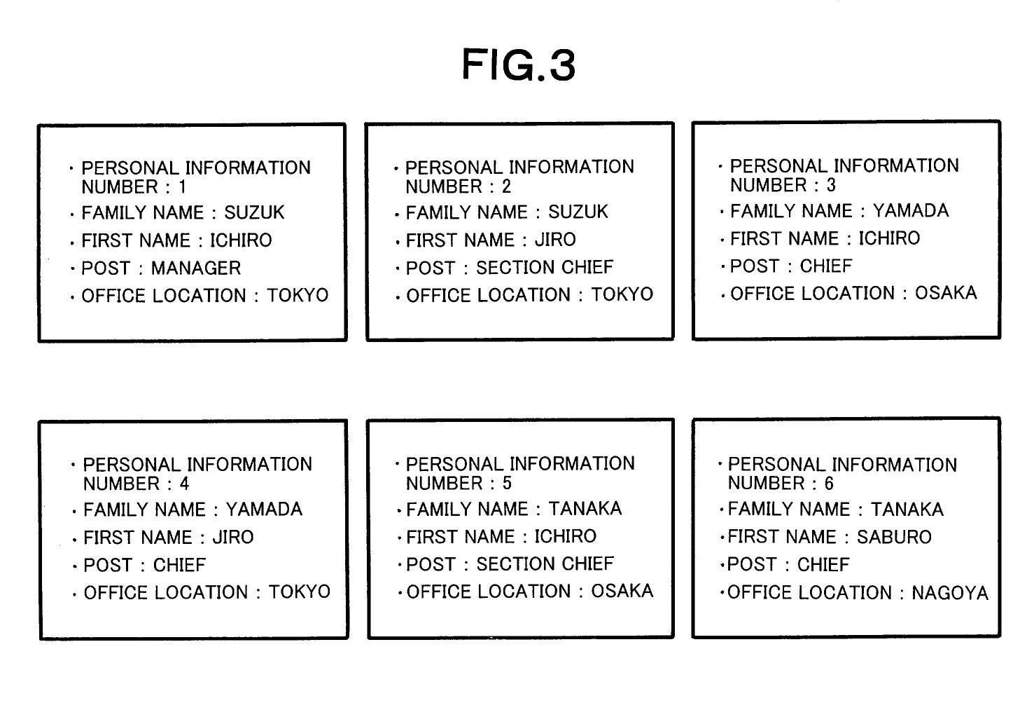

FIG. 3 is a plan view showing an example of pieces of personal information stored in the personal information storage section 31. As shown in FIG. 3, each personal information includes “personal information number” and a plurality of categories (definitions) such as “family name”, “first name”, “post” and “office location” as personal data. The personal data can be defined by “age”, “sex”, “length of service”, “salary” and the like. Alternatively, the personal data can be defined so that a plurality of pieces of data are stored for one category such as “qualifications held—ordinary driver's license, type 1 information processing, . . . ”.

If a document is to be referred in the access right management system in the embodiment according to the present invention, the name of the document to be referred, and the personal information number of a person, who is to refer to the document, are transmitted from the document reference apparatus 1 to the document reference section 21 of the document storage apparatus 2 through the transmission line 51. The document reference section 21 fetches document data from the document storage section 22 based on the document name which the document reference section 21 receives, and transmits the personal information number to the reference section 33 of the personal information storage apparatus 3 through the transmission line 52. The reference section 33 of the personal information storage apparatus 3 fetches personal information from the personal information storage section 31 based on the personal information number which the reference section 33 receives, and transmits the fetched result to the document reference section 21 of the document storage apparatus 2 through the transmission line 52.

Here, the document reference section 21 passes the personal information transmitted from the personal information storage apparatus 2 and the document data fetched from the document storage section 22, to the condition determination section 23. The condition determination section 23 determines whether or not an access is acceptable. The condition determination section 23 transmits a determination result indicating whether or not the access is acceptable, to the document reference section 21.

If the determination result indicates that the access is acceptable, the document reference section 21 transmits the document data to the document reference apparatus 1 through the transmission line 51. If the determination result indicates that the access is rejected, the document reference section 21 transmits an access rejection notification to the document reference apparatus 1.

The detailed operation examples of the access right management system in the first embodiment according to the present invention will be described below.

The name of the document requested from the document reference apparatus 1 and the personal information number of a person who requests the document are transmitted to the document reference section 21 of the document storage apparatus 2 through the transmission line 51. The document reference section 21 fetches the document data requested from the document reference apparatus 1 from the document storage section 22 based on the document name. Assuming that the requested document data does not exists in the document storage section 22, the document reference section 21 notifies the document reference apparatus 1 through the transmission line 51 that the requested document data does not exist.

Next, the document reference section 21 transmits the personal information number transmitted from the document reference apparatus 1, to the reference section 33 of the personal information storage apparatus 3 through the transmission line 52. The reference section 33 fetches personal information from the personal information storage section 31 based on the personal information number transmitted from the document storage apparatus 2, and transmits the fetched personal information to the document reference section 21 of the document storage apparatus 2 through the transmission line 52. Assuming that the personal information on the requested personal information number does not exist in the personal information storage section 31, the reference section 33 notifies the document reference section 21 through the transmission line 52 that the personal information corresponding to the requested personal information number does not exist.

The document reference section 21 passes the document data fetched from the document storage section 22 and the personal information transmitted from the personal information storage apparatus 3, to the condition determination section 23. The condition determination section 23 compares the condition of the document data (conditional formula) with the personal information, determines whether or not an access is acceptable, and passes the determination result to the document reference section 21.

The document data conditional formula can be freely expressed (defined) using such symbols as “(‘,’)”, “and””, “or”, “=”, ”, ”≧”, “≠”, in the following format:

(“post”=“chief” and “post”≦“section chief”) or “office location”=“Osaka”.

If receiving the result that no personal information exists from the personal information storage apparatus 3, the condition determination section 23 passes the result that the access is rejected, to the document reference section 21. The document reference section 21 transmits the access rejection result to the document reference apparatus 1 through the transmission line 51.

If receiving the result that the access is acceptable from the condition determination section 23, the document reference section 21 transmits the document data fetched from the document storage section 22, to the document reference apparatus 1 through the transmission line 51.

The operation of the access right management system in the first embodiment will be described concretely using the document data shown in FIG. 2 and the personal information shown in FIG. 3.

As the first concrete example, if a document with a document name “ABC” is requested by a user with a personal information number 1, the document reference apparatus 1 transmits the document name “ABC” and the personal information number 1 to the document reference section 21 of the document storage apparatus 2 through the transmission line 51.

The document reference section 21 fetches document data from the document storage section 22 based on the document name “ABC” transmitted from the document reference apparatus 1, and acquires personal information stored in the personal information storage section 31 of the personal information storage apparatus 3 based on the personal information number 1 through the transmission line 52. The document reference section 21 acquires the document 1 shown in FIG. 2 from the document storage section 21, acquires the personal information on the personal information number 1 shown in FIG. 3 from the personal information storage apparatus 3, and transmits these pieces of information to the condition determination section 23. The condition determination section 23 compares the information (document 1 and personal information on the personal information number 1) transmitted from the document reference section 21 with each other and determines whether or not an access is acceptable.

The condition of the document 1 is that “if post is chief and office location is Tokyo, access is acceptable”. The personal information on the personal information number 1 is that “post is manager, and office location is Tokyo”. Therefore, the condition determination section 23 transmits to the document reference section 21 that the access is rejected. Since receiving the access rejection result, the document reference section 21 transmits the access rejection result to the document reference apparatus 1 through the transmission line 51.

As the second concrete example, if a document with a document name “XYZ” is requested by the user with the personal information number 1, the document reference apparatus 1 transmits the document name “XYZ”” and the personal information number 1 to the document reference section 21 through the transmission line 51.

The document reference section 21 intends to acquire document data on the document name “XYZ” from the document storage section 21. However, the requested document does not exist, the document reference section 21 receives a result that the requested document does not exist, and transmits to the document reference apparatus 1 through the transmission line 51 the result that the requested document does not exist.

As the third concrete example, if a user with a personal information number 7 requests the document with the document name “ABC”, the reference section 33 of the personal information storage apparatus 3 intends to acquire personal information based on the personal information number 7 from the personal information storage section 31. However, since the requested personal information does not exist, the reference section 33 transmits a result that no personal information exists, to the document reference section 21 of the document storage apparatus 2 through the transmission line 52.

If receiving the result that the personal information corresponding to the personal information number 7 does not exist, from the personal information storage apparatus 3, the document reference section 21 transmits the document 1 acquired from the personal storage section 22 and the result that the corresponding personal information does not exist, to the condition determination section 23. If receiving the result that the corresponding personal information does not exist, the condition determination section 23 transmits a result that an access is rejected, to the document reference section 21. The document reference section 21 transmits the access rejection result received from the condition determination section 23, to the document reference apparatus 1 through the transmission line 51.

<Second Embodiment>

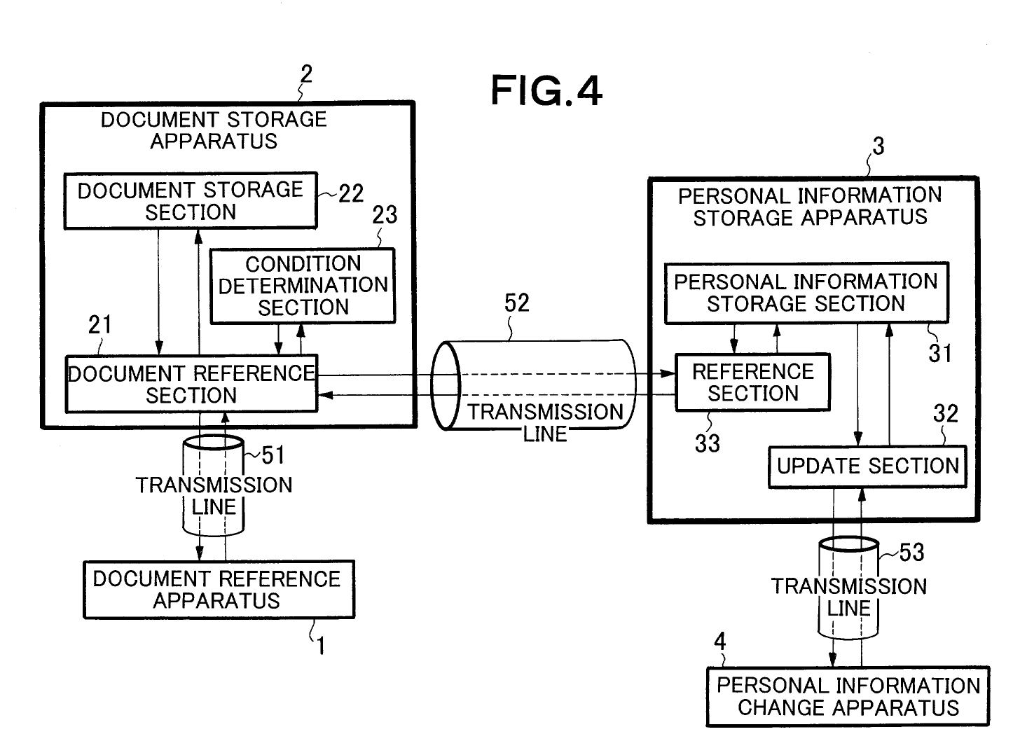

FIG. 4 is a block diagram showing the schematic configuration of the second embodiment in which the access management system according to the present invention is applied to document data management. In FIG. 4, the access management system in the second embodiment of the present invention includes a document reference apparatus 1, a document storage apparatus 2, a personal information storage apparatus 3, and a personal information change apparatus 4. The document reference apparatus 1 and the document storage apparatus 2 are connected to each other through a transmission line 51. The document storage apparatus 2 and the personal information storage apparatus 3 are connected to each other through a transmission line 52. The personal information storage apparatus 3 and the personal information change apparatus 4 are connected to each other through a transmission line 53.

In the second embodiment of the present invention, the same constituent elements as those in the first embodiment stated above of the present invention will be denoted by the same reference numerals, respectively, and will not be described herein.

The access right management system in the second embodiment of the present invention differs from that in the first embodiment in configuration, i.e., the personal information change apparatus 4 is connected to the update section 32 of the personal information storage apparatus 3 through the transmission line 53.

If personal information is to be changed in the access right management system in the second embodiment of the present invention, the personal information change apparatus 4 transmits to-be-updated personal information number and personal information to the update section 32 of the personal information storage apparatus 3 through the transmission line 53.

The update section 32 changes (performs an update processing to) the personal information stored in the personal information storage section 31 based on the personal information number and the personal information transmitted from the personal information change apparatus 4. The personal information storage section 31 transmits a result indicating whether or not the update processing is successful, to the update section 32. If the update processing is successful, the update section 32 transmits a result indicating that the update processing is successful, to the personal information change apparatus 4 through the transmission line 53. If the update processing is unsuccessful, the update section 32 transmits a result indicating that the update processing is unsuccessful, to the personal information change apparatus 4 through the transmission line 53.

The detailed operation example of the access right management system in the second embodiment of the present invention will be described.

If personal information already registered in the personal information storage apparatus 3 is to be changed, the personal information change apparatus 4 transmits a registered personal information number and changed personal information, to the update section 32 of the personal information storage apparatus 3 through the transmission line 53.

The update section 32 changes (performs an update processing to) the personal information stored in the personal information storage section 31 based on the personal information number and changed personal information transmitted from the personal information change apparatus 3. The personal information storage section 31 transmits a result indicating whether or not the update processing is successful, to the update section 32. If the result which indicates that the update processing is successful is transmitted from the personal information storage section 31, the update section 32 transmits the result indicating that the update processing is successful, to the personal information change apparatus 4 through the transmission line 53. If not, the update section 32 transmits the result indicating that the update processing is unsuccessful, to the personal information change apparatus 4 through the transmission line 53.

If personal information is to be updated (or added) in the access right management system in the second embodiment of the present invention, the personal information change apparatus 4 transmits a personal information update instruction, the personal information number and the to-be-updated personal information, to the update section 32 of the personal information storage section 3 through the transmission line 53.

The update section 32 transmits the personal information updated based on the personal information number transmitted from the personal information change apparatus 4, to the personal information storage section 31. The personal information storage section 31 performs an update processing. If the update processing is successful, the personal information storage section 31 transmits a result indicating that the update processing is successful and the personal information number of the updated personal information, to the update section 32. If the update processing is unsuccessful, the personal information storage section 31 transmits a result indicating that the update processing is unsuccessful, to the update section 32.

If the result transmitted from the personal information storage section 31 indicates that the update processing is successful, the update section 32 transmits the result indicating that the update processing is successful and the personal information number of the updated personal information, to the personal information change apparatus 4 through the transmission line 53. If the result indicates that the update processing is unsuccessful, the update section 32 transmits the result indicating that the update processing is unsuccessful, to the personal information change apparatus 4 through the transmission line 53.

If already existing personal information is to be deleted, the personal information change apparatus 4 transmits a deletion instruction and the to-be-deleted personal information, to the update section 32 of the personal information storage apparatus 3 through the transmission line 53.

The update section 32 deletes the personal information on the personal information number which is transmitted from the personal information change apparatus 4, from the personal information storage section 31. If a deletion processing is successful, the personal information storage section 31 transmits a result indicating that the deletion processing is successful, to the update section 32. If the deletion processing is successful, the personal information storage section 31 transmits a result indicating that the deletion processing is unsuccessful, to the update section 32. If the result transmitted from the personal information storage section 31 indicates that the deletion processing is successful, the update section 32 transmits the result indicating that the deletion processing is successful, to the personal information change apparatus 4 through the transmission line 53. If the result indicates that the deletion processing is unsuccessful, the update section 32 transmits the result indicating that the deletion processing is unsuccessful to the personal information change apparatus 4 through the transmission line 53.

The operation of the access right management system in the second embodiment will be described concretely using the document data shown in FIG. 2 and the personal information shown in FIG. 3.

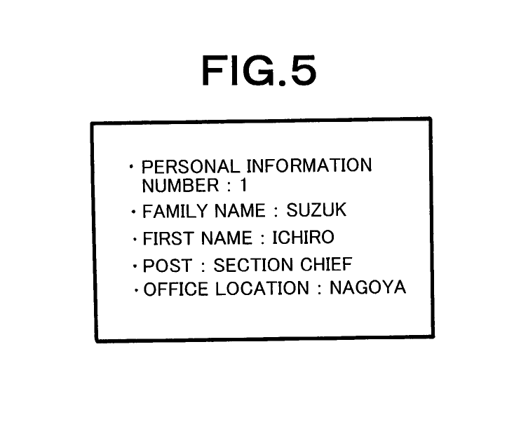

As the fourth concrete example, if the post of Ichiro Suzuki with the personal information number 1 is changed from manager to section chief and his office location is changed from Tokyo to Nagoya by reshuffle, the personal information change apparatus 4 transmits the personal information number 1 and personal information for update as shown in FIG. 5, to the update section 32 of the personal information storage apparatus 3 through the transmission line 53.

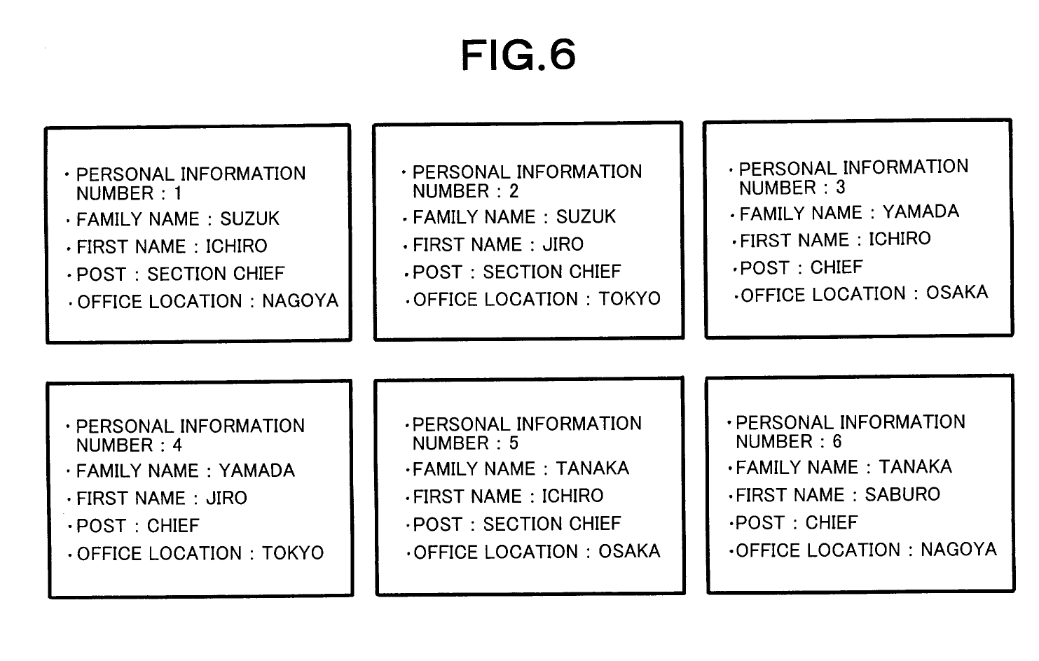

The update section 32 performs an update processing to the personal information stored in the personal information storage section 31 based on the personal information number 1 and the personal information for update transmitted from the personal information change apparatus 4. If the update processing is successful, the personal information managed on a person-by-person basis and stored in the personal information storage section 31 turns into a state shown in FIG. 6, which indicates that the personal information on the personal information number 1 is updated.

If the update processing is successful as shown in FIG. 6, the personal information storage section 31 transmits the result indicating that the update processing is successful, to the update section 32. If the update processing is unsuccessful, the personal information storage section 31 transmits a result indicating that the update processing is unsuccessful, to the update section 32.

If the result transmitted from the personal information storage section 31 indicates that the update processing is successful, the update section 32 transmits the result indicating that the update processing is successful, to the personal information change apparatus 4 through the transmission line 53. If the result indicates that the update processing is unsuccessful, the update section 32 transmits the result indicating that the update processing is unsuccessful to the personal information change apparatus 4 through the transmission line 53.

As the fifth concrete example, if Ichiro Suzuki with the personal information number 1 retires from office and his personal information stored in the personal information storage section 31 of the personal information storage apparatus 3 is to be deleted, the personal information change apparatus 4 transmits the personal information number 1 and a deletion instruction to the update section 32 of the personal information storage apparatus 3 through the transmission line 53.

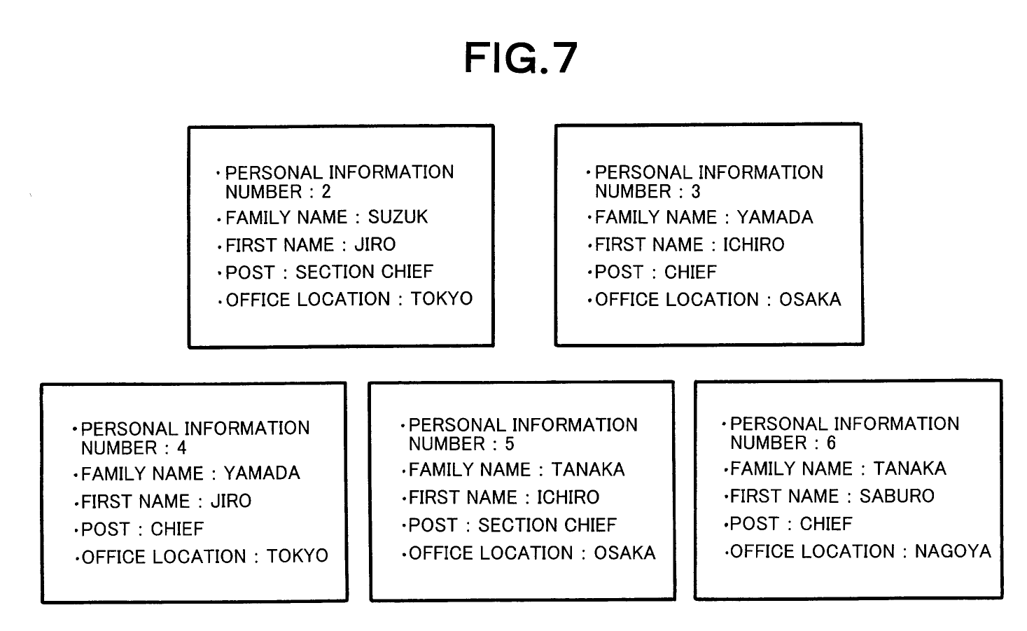

The update section 32 deletes the personal information on the personal information number 1 transmitted from the personal information change apparatus 4, from the personal information storage section 31. If the personal information on the personal information number 1 is successfully deleted, the personal information storage section 31 transmits a result indicating that a deletion processing is successful, to the update section 32. If the deletion of the personal information on the personal information number 1 is unsuccessful, the personal information storage section 31 transmits a result indicating that the deletion processing is unsuccessful, to the update section 32. If the deletion processing is successful, the personal information managed on a person-by-person basis and stored in the personal information storage section 31 turns into a state shown in FIG. 7, which indicates that the personal information on the personal information number 1 is deleted.

If the result transmitted from the personal information storage section 31 indicates that the deletion processing is successful, the update section 32 transmits the result indicating that the deletion processing is successful, to the personal information change apparatus 4 through the transmission line 53. If the result indicates that the deletion processing is unsuccessful, the update section 32 transmits the result indicating that the deletion processing is unsuccessful, to the personal information change apparatus 4 through the transmission line 53.

Each of the document reference apparatus 1, the document storage apparatus 2, the personal information storage apparatus 3, and the personal information change apparatus 4 in the first and second embodiment described above of the present invention, consists of a control section (CPU) which controls the operation of the apparatus, a storage section (ROM) which stores an operation program, and a work area (RAM) which develops the operation program.

According to the embodiments of the present invention, by managing access right for accessing document data to which a user desires to refer on a person-by-person basis, it becomes unnecessary to manage the access right of all groups as seen in the conventional system. That is, while a system which manages the personal information in groups is conventionally established, the present invention does not have a concept of groups but is made based on the viewpoint of personal information on each person. Based on the reference condition (conditional formula) allocated for each data, it is determined to which person an access right is authorized. Therefore, even if personal information is to be updated (changed), not only the person permitted to update group information, as seen in the conventional system, but also all users the personal information of whom are stored, can appropriately update (change) the personal information.

The embodiments stated above are preferred embodiments of the present invention. They can be carried out by being variously changed or modified within the scope of the present invention. For example, while the above embodiments of the present invention relate to the access right management for accessing document data. The access target is not limited to the document data but may be arbitrary data in such a data format that the data can be transmitted and received through transmission lines. Further, the transmission lines (51 to 53) employed in the embodiments of the present invention may be established either as the same network or different networks.

As is obvious from the above, the present invention can exhibit the following advantages.

The first advantage of the present invention is as follows. Since not less than 0 group to which each person belongs, can be described in each personal information, it is possible to dispense with the management of users included in groups. If a group to which a certain person belongs is to be changed, access right can be changed only by changing the group included in the personal information on the certain person.

The second advantage of the present invention is as follows. If personal information is to be changed by reshuffle or the like, it suffices to change only the personal information on a corresponding person and it is unnecessary to change access right information on each file. It is, therefore, possible to decrease man-hours for operation required for following the change of the personal information.

The third advantage of the present invention is as follows. Since the corresponding person on the personal information manages their own personal information, the personal information can be updated by the corresponding person himself or herself, which can decrease man-hours for operation.

The fourth advantage of the present invention is as follows. If there exist, for example, groups Ga and Gb, it is unnecessary to prepare a group Gab which is constituted by users who belong to the both groups Ga and Gb. Instead, “if a person is included in groups Ga and Gb, access is acceptable (or rejected)” can be described in the conditional formula of the file, making it possible to decrease the number of groups.

What is claimed is:

1. An access right management system comprising:
a storage apparatus storing a plurality of pieces of data;
a reference apparatus referring to the data stored in the storage apparatus; and
a personal information storage apparatus storing a plurality of pieces of personal information used to determine an access right for accessing desired data from the reference apparatus, wherein
the storage apparatus, the reference apparatus, and the personal information storage apparatus are connected through transmission lines, and
the plurality of pieces of personal information are managed on a person-by-person basis.

2. The access right management system according to claim 1, wherein
the storage apparatus comprises:
data storage means for allocating reference conditions to the plurality of pieces of data, and storing the plurality of pieces of data allocated the reference conditions;
data reference means for acquiring the desired data and the reference condition of the desired data from the storage means in response to a data reference request transmitted from the reference apparatus, and for acquiring personal information for determining whether the access right for accessing the desired data is to be authorized, from the personal information storage apparatus; and
condition determination means for determining whether or not the personal information coincides with the reference condition of the desired data acquired from the data reference means.

3. The access right management system according to claim 2, wherein
if the personal information coincides with the reference condition of the desired data, the storage apparatus causes the condition determination means to transmit the desired data to the reference apparatus, and
if the personal information does not coincide with the reference condition of the desired data, the storage apparatus causes the condition determination means to transmit a notification that an access to the desired data is rejected, to the reference apparatus.

4. The access right management system according to claim 1, wherein
the personal information comprises:
a personal information number specific to a person; and
personal data consisting of a plurality of categories used to determine the access right for accessing the desired data.

5. The access right management system according to claim 4, wherein
the personal information storage apparatus comprises:
personal information storage means for storing the plurality of pieces of personal information; and
personal information reference means for acquiring one of the plurality of pieces of personal information stored in the personal information storage means based on the personal information number transmitted together with a personal information acquisition request from the storage apparatus in response to the personal information acquisition request transmitted from the storage apparatus, and for transmitting the acquired personal information to the storage apparatus.

6. The access right management system according to claim 5, wherein
if the personal information based on the personal information number transmitted together with the personal information acquisition request is not stored in the personal information storage means, the personal information reference means transmits a notification, that the personal information does not exist, to the storage means.

7. The access right management system according to claim 5, wherein
the personal information storage apparatus comprises:
update means for updating the plurality of pieces of personal information stored in the personal information storage means.

8. The access right management system according to claim 7, comprising:
a personal information change apparatus changing the personal information stored in the personal information storage means, from an outside of the access right management system, wherein
the update means updates the personal information stored in the personal information storage means based on the personal information number and a change content of the personal information transmitted from the personal information change apparatus.

9. A method for managing an access right management system in which a storage apparatus storing a plurality of pieces of data, a reference apparatus referring to the data stored in the storage apparatus, and a personal information storage apparatus storing a plurality of pieces of personal information used to determine an access right for accessing desired data from the reference apparatus are connected through transmission lines, the method comprising:
a reference request transmission step of causing the reference apparatus to transmit a data name of data to which a person desires to refer and a personal information number of the person who desires to refer to the data, to the storage apparatus;
a data acquisition step of causing the storage apparatus to acquire the data based on the data name transmitted in the reference request transmission step;
a personal information acquisition step of causing the storage apparatus to acquire the personal information based on the personal information number, from the personal information storage apparatus;
a determination step of causing the storage apparatus to determine whether or not the personal information acquired in the personal information acquisition step coincides with a reference condition allocated to the data acquired in the data acquisition step; and
a transmission step of causing the storage apparatus to transmit the desired data to the reference apparatus if the personal information coincides with the reference condition, and to transmit a notification that an access is rejected to the reference apparatus if the personal information does not coincide with the reference condition.

10. The method for managing an access right management system according to claim 9, wherein
the personal information comprises:
the personal information number specific to the person; and
personal data consisting of a plurality of categories used to determine the access right for accessing the desired data.

11. The method for managing an access right management system according to claim 10, comprising:
a personal information storage step of causing the personal information storage apparatus to store the plurality of pieces of personal information on a person-by-person basis; and
a personal information reference step of causing the personal information storage apparatus to acquire the personal information stored in the personal information storage step based on the personal information number transmitted together with a personal information acquisition request transmitted from the storage apparatus in the personal information acquisition step, in response to the personal information acquisition request, and to transmit the acquired personal information to the storage apparatus.

12. The method for managing an access right management system according to claim 11, wherein
in the personal information reference step, if the personal information based on the personal information number transmitted together with the personal information acquisition request is not stored in the personal information storage step, the personal information storage apparatus transmits a notification, that the personal information does not exist, to the storage apparatus.

13. The method for managing an access right management system according to claim 11, comprising:
an update step of causing the personal information storage apparatus to update the plurality of pieces of personal information stored in the personal information storage step.

14. The method for managing an access right management system according to claim 13, wherein
the access right management system comprises:
a personal information change apparatus changing the personal information stored in the personal information storage apparatus, from an outside of the access right management system, and wherein
in the update step, the personal information storage apparatus updates the personal information stored in the personal information storage step based on the personal information number and a change content of the personal information transmitted from the personal information change apparatus.

15. A computer program product which is embodied on a computer-readable medium and provided for an access right management system, the system comprising:
a storage apparatus storing a plurality of pieces of data;
a reference apparatus referring to the data stored in the storage apparatus; and
a personal information storage apparatus storing a plurality of pieces of personal information consisting of a plurality of categories used to determine an access right for accessing desired data from the reference apparatus, wherein
the storage apparatus, the reference apparatus, and the personal information storage apparatus are connected through transmission lines, and wherein
the computer program product causes the reference apparatus to execute a reference request transmission processing of transmitting a data name of data to which a person desires to refer and a personal information number of the person who desires to refer to the data, to the storage apparatus;
the computer program product causes the storage apparatus to execute a data acquisition processing of acquiring the data based on the data name transmitted by the reference request transmission processing;
the computer program product causes the storage apparatus to execute a personal information acquisition processing of acquiring the personal information based on the personal information number, from the personal information storage apparatus;
the computer program product causes the storage apparatus to execute a determination processing of determining whether or not the personal information acquired in the personal information acquisition step coincides with a reference condition allocated to the data acquired by the data acquisition processing; and
the computer program product causes the storage apparatus to execute a transmission processing of transmitting the desired data to the reference apparatus if the personal information coincides with the reference condition, and of transmitting a notification that an access is rejected to the reference apparatus if the personal information does not coincide with the reference condition.

16. The computer program product according to claim 15, wherein
the personal information comprises:
the personal information number specific to the person; and
personal data consisting of a plurality of categories used to determine the access right for accessing the desired data.

17. The computer program product according to claim 16, wherein
the computer program product causes the personal information storage apparatus to execute a personal information storage processing of storing the plurality of pieces of personal information on a person-by-person basis; and
the computer program product causes the personal information storage apparatus to execute a personal information reference processing of acquiring the personal information stored by the personal information storage processing based on the personal information number transmitted together with a personal information acquisition request transmitted from the storage apparatus by the personal information acquisition processing, in response to the personal information acquisition request, and of transmitting the acquired personal information to the storage apparatus.

18. The computer program product according to claim 17, wherein
in the personal information reference processing, if the personal information based on the personal information number transmitted together with the personal information acquisition request is not stored by the personal information storage processing, the personal information storage apparatus transmits a notification, that the personal information does not exist, to the storage apparatus.

19. The computer program product according to claim 17, wherein
the computer program product causes the personal information storage apparatus to execute an update processing of updating the plurality of pieces of personal information stored by the personal information storage processing.

20. The computer program product according to claim 19, wherein
the access right management system comprises:
a personal information change apparatus changing the personal information stored in the personal information storage apparatus, from an outside of the access right management system, and wherein
in the update processing, the personal information storage apparatus updates the personal information stored by the personal information storage step based on the personal information number and a change content of the personal information transmitted from the personal information change apparatus.
